(19) United States
(12) Patent Application Publication
(10) Pub. No.: US 2013/0046873 A1
(43) Pub. Date: Feb. 21, 2013

(54) APPARATUS AND METHOD FOR PRODUCING MULTIMEDIA PACKAGE, SYSTEM AND METHOD FOR PROVIDING MULTIMEDIA PACKAGE SERVICE

(71) Applicants: Ji Hye O, Daegu (KR); Eun Chang Choi, Daejeon (KR)

(72) Inventors: Ji Hye O, Daegu (KR); Eun Chang Choi, Daejeon (KR)

(73) Assignee: Electronics and Telecommunications Research Institute, Daejeon (KR)

(21) Appl. No.: 13/524,954

(22) Filed: Jun. 15, 2012

(30) Foreign Application Priority Data
Aug. 19, 2011 (KR) 10-2011-0083064

(51) Int. Cl. G06F 15/173

(52) U.S. Cl. 709/223

(57) ABSTRACT

Provided is an apparatus for producing a multimedia package, including: a package configuration and environment setting unit selecting multimedia resources to constitute the multimedia package from multimedia resources stored in a server or a client and setting a playback sequence and a playback environment for the selected multimedia resources; and a package file generation unit generating the multimedia package file according to the set playback sequence and playback environment by using the selected multimedia resources.

### CROSS-REFERENCE TO RELATED APPLICATIONS

This application claims priority to and the benefit of Korean Patent Application No. 10-2011-0083064 filed in the Korean Intellectual Property Office on Aug. 19, 2011, the entire contents of which are incorporated herein by reference.

### TECHNICAL FIELD

The present invention relates to an apparatus and a method for producing a multimedia package that can allow a user to produce multimedia contents of a package type by using multimedia such as an image, an audio, a video, a text, and the like.

### BACKGROUND ART

At present, as multimedia related services, various services such as download and streaming of a sound source or a moving picture, a digital pictorial, and the like are provided. In particular, with development of a wireless communication technology and growth of utilization of various smart apparatuses, multimedia contents of a combination type of a sound source, a moving picture, an image, a text, and the like are combined are provided in the form of an application.

The contents of the combination type of various types of multimedia are called a multimedia package. An example of the multimedia package may include albums in which sound sources, moving pictures, and pictorials of singers or musicians are collected. When a user downloads a multimedia package application on a terminal, the user can mitigate inconvenience in retrieving or downloading desired contents one by one.

However, since the multimedia package application is produced according to an intention which a content author has already planned, it is difficult to provide the multimedia package application configured by contents which users want and there is a limit in reflecting demands of all the users.

By an existing service or technology, it is difficult for general persons without a technical knowledge of producing the multimedia contents to produce desired multimedia contents and it is difficult to reflect individual consumers' tastes with only multimedia contents produced by an expert group.

### SUMMARY OF THE INVENTION

When a user selects contents to produce a multimedia package, a multimedia content author and general users can produce the multimedia package according to individual intentions.

The present invention has been made in an effort to provide a system and a method for producing a multimedia package, and a system and a method for providing a multimedia package service that can allow general users without technical knowledge of producing contents to produce the multimedia package according to their tastes by using multimedia contents provided in the service or their possessed multimedia contents.

An exemplary embodiment of the present invention provides an apparatus for producing a multimedia package, including: a package configuration and environment setting unit selecting multimedia resources to constitute the multimedia package from multimedia resources stored in a server or a client and setting a playback sequence and a playback environment for the selected multimedia resources; and a package file generation unit generating the multimedia package file according to the set playback sequence and playback environment by using the selected multimedia resources.

The apparatus may be provided in the client.

The apparatus may further include a resource management unit automatically retrieving and finding the multimedia resource in a storage device of the client, retrieving the multimedia resource according to a request from a user, and providing the multimedia resource to the package file generation unit.

The package configuration and environment setting unit may configure a list of the selected multimedia resources and information on the playback sequence and the playback environment as the header of the multimedia package file to provide the header to the package file generation unit, and the package file generation unit may generate the multimedia package file by using the header and the selected multimedia resources.

The apparatus may further include a package management unit storing and managing the generated multimedia package file.

The apparatus may further include a package file playback unit playing back the generated multimedia package file.

The package file playback unit may generate and display a playback list of contents and set the playback environment based on a header of a multimedia package file to be executed.

Another exemplary embodiment of the present invention provides a method for producing a multimedia package, including: selecting multimedia resources to constitute the multimedia package from multimedia resources stored in a server or a client and setting a playback sequence and a playback environment for the selected multimedia resources; and generating the multimedia package file according to the selected multimedia resources and the set playback sequence and playback environment.

The setting of the playback sequence and the playback environment and the generating of the multimedia package file may be performed by the client.

The method may further include configuring a list of the selected multimedia resources and information on the playback sequence and the playback environment as the header of the multimedia package file, and in the generating of the multimedia package file, the multimedia package file may be generated by using the header and the selected multimedia resources.

Yet another exemplary embodiment of the present invention provides a system for providing a multimedia package service, including: a client-side resource management unit managing a multimedia resource stored in a client; a package configuration and environment setting unit selecting multimedia resources to constitute the multimedia package from multimedia resources stored in a server or the client and setting a playback sequence and a playback environment for the selected multimedia resources; a client-side package file generation unit generating the multimedia package file according to the set playback sequence and playback environment by using the multimedia resources stored in the client; a server-side resource management unit managing the multimedia resource stored in the server; and a server-side package file generation unit generating the multimedia package file according to the set playback sequence and playback environment by using the multimedia resource stored in the server.

The server-side resource management unit may manage classification information, a copyrighter, and information on a use right for the multimedia resource stored in the server.

The client-side resource management unit may manage information on a file name, a format, and a multimedia type for the multimedia resource stored in the client.

The server-side package file generation unit may transmit the generated multimedia package file to the client.

Still another exemplary embodiment of the present invention provides a method for providing a multimedia package service, including: registering member information of a member to receive the service and performing member authentication; selecting multimedia resources to constitute a multimedia package from multimedia resources stored in a server or the client, in the client of the member, and setting a playback sequence and a playback environment for the selected multimedia resources; and generating a multimedia package file according to the selected multimedia resources and the set playback sequence and playback environment.

The generating of the multimedia package file may be performed by the server or the client.

The method may further include transmitting the generated multimedia package file to the client when the multimedia package file is generated in the server.

According to the exemplary embodiments of the present invention, even general users without technical knowledge of producing contents can produce a multimedia package according to their tastes by using multimedia contents provided in a service or their possessed multimedia contents. The users can produce the multimedia package by using multimedia shared by other users or servers in addition to their possessed multimedia and possess the multimedia package configured according to their tastes. Accordingly, an environment capable of generating various multimedia contents is provided and user's desired multimedia contents can be serviced.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a known method for providing a multimedia package service for ease of understanding the present invention.

FIG. 2 illustrates an overview of an apparatus and a method for producing a multimedia package and a method for providing a multimedia package service according to an exemplary embodiment of the present invention.

FIG. 3 illustrates a system for providing a multimedia package service, including the apparatus for producing a multimedia package according to the exemplary embodiment of the present invention.

FIG. 4 illustrates a configuration of a resource management unit 110.

FIG. 5 illustrates a configuration of a resource management unit 240.

FIG. 6 illustrates configurations of a package configuration and an environment setting unit 210.

FIG. 7 illustrates a configuration of a package file generating unit 220.

FIG. 8 illustrates a configuration of a package file playback unit 250.

FIG. 9 is a flowchart illustrating a method for producing a multimedia package by the apparatus for producing a multimedia package of FIG. 3 according to an exemplary embodiment of the present invention.

FIG. 10 illustrates an example of a file architecture of a multimedia package file.

FIG. 11 is a flowchart illustrating a method for the package file playback unit 250 to execute the multimedia package file.

FIG. 12 illustrates an example of a playback list of all contents included in the multimedia package file.

FIG. 13 illustrates an overall configuration of a system for providing a multimedia package service according to the exemplary embodiment of the present invention.

FIG. 14 illustrates a system for performing the method for providing a multimedia package service according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Throughout the specification, like reference numerals in each drawing denotes like components. In describing the present invention, well-known functions or constructions will not be described in detail since they may unnecessarily obscure the understanding of the present invention.

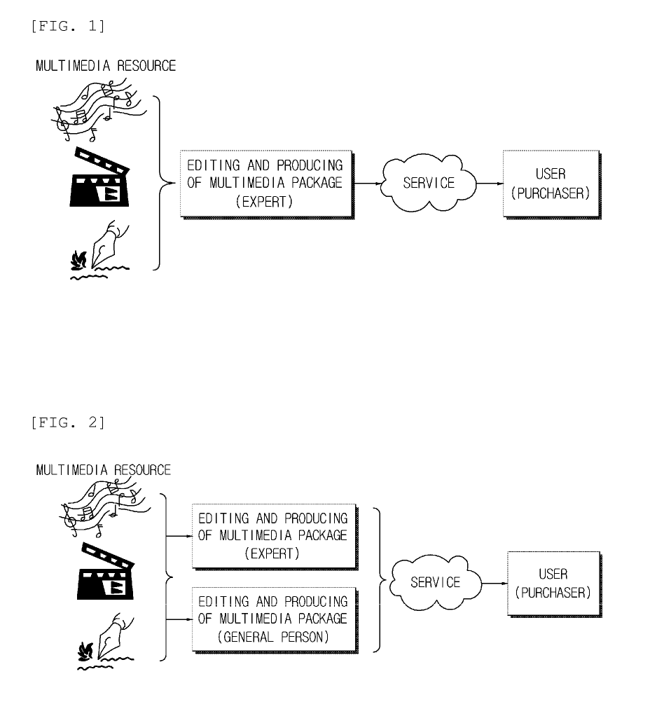

FIG. 1 illustrates a known method for providing a multimedia package service for ease of understanding the present invention. Referring to FIG. 1, an expert produces a multimedia package by using editing and writing tools with a multimedia resource such as a sound source, a moving picture, a text, or the like and a user purchases the multimedia package through the service. The multimedia package may be produced in a type such as a CD, a DVD, or an application (for example, a digital pictorial and an album application for a smart apparatus). The multimedia package may include a content which a user does not desire in some cases and the user cannot but pay for even the cost for the undesired contents.

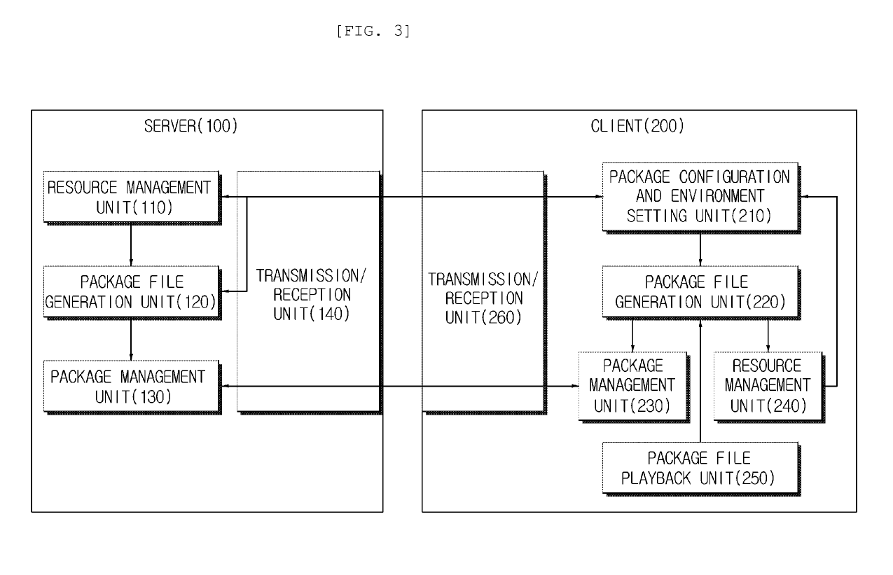

FIG. 2 illustrates an overview of an apparatus and a method for producing a multimedia package and a method for providing a multimedia package service according to an exemplary embodiment of the present invention. Referring to FIG. 2, a general person without the technical knowledge of producing the multimedia contents as well as an expert group may also produce and enjoy the multimedia package by using the apparatus and the method for producing a multimedia package according to the exemplary embodiment of the present invention.

FIG. 3 illustrates a system for providing a multimedia package service, including the apparatus for producing a multimedia package according to the exemplary embodiment of the present invention. The system for providing a multimedia package service generally includes a server 100 provided at a service provider side and a client 200 provided at a user side. The apparatus for producing a multimedia package is generally provided in the client 200, but some components may be present throughout the server 100. The client 200, as a terminal that provides a computing environment to the user, may be, for example, a personal computer, a notebook, a tablet PC, a smart apparatus such as a smart phone, and the like.

The server 100 includes a resource management unit 110, a package file generation unit 120, a package management unit 130, and a transmission/reception unit 140. The client 200 includes a package configuration and environment setting unit 210, a package file generation unit 220, a package management unit 230, a resource management unit 240, a package file playback unit 250, and a transmission/reception unit 260. The system for providing a multimedia package service according to the exemplary embodiment of the present invention produces the multimedia package by using the multimedia resource managed by the server or client and executes the produced multimedia package in the client. In the specification, the multimedia resource, as a multimedia file capable of constituting the multimedia package, includes an audio, a moving picture, an image, a text, and the like stored in the server or client. Hereinafter, the ‘multimedia resource’ will be referred to as a ‘resource’ for convenience.

The resource management unit 110 at the server 100 side processes management and input/output operations of the resource stored in the server 100.

FIG. 4 illustrates a configuration of a resource management unit 110. The resource management unit 110 includes a resource storing and managing interface 111, a resource database 112, a resource retrieval processing portion 113, and a resource output interface 114.

Since the resource stored in the server 100 is a resource which is commonly used, additional information on the resource is required for easy retrieval. The information may include, for example, classification information (a genre, contents, a writing year, a singer, and the like), a content copyrighter, a content use right, and the like. When the content use right is given, the corresponding resource may be differentially provided to each user, and when additional information such as a content use period or a content selling quantity is added thereto, the corresponding resource may be provided during only a predetermined period or only a limited quantity may be provided.

The resource storing and managing interface 111 is an interface for storing and managing the resource from the server or a remote place in a database. The resource from the server or remote place is stored in the resource database 112. When the client 200 transmits a query word or a retrieval word for the client 200 to retrieve the resource stored in the server 100, the resource retrieval processing portion 113 retrieves the resource database 112 to transmit the corresponding retrieval result to the client 200. The resource retrieval processing portion 113 retrieves the resource database 112 according to a request from the package configuration and environment setting unit 210 of the client 200.

The resource output interface 114 serves to transfer the resource required to generate the multimedia package from the resource database 112 to the package file generation unit 120.

The resource management unit 240 at the client 200 side processes management and input/output operations of the resource stored in the client 200. The resource management unit 240 manages the resource so as to produce the multimedia package by using the resource stored in the client 200.

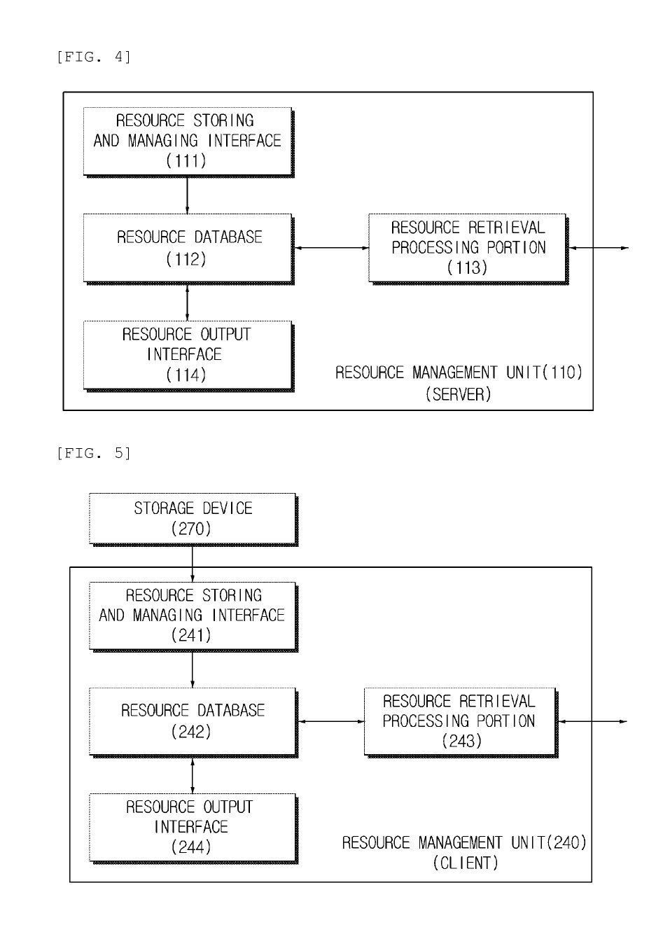

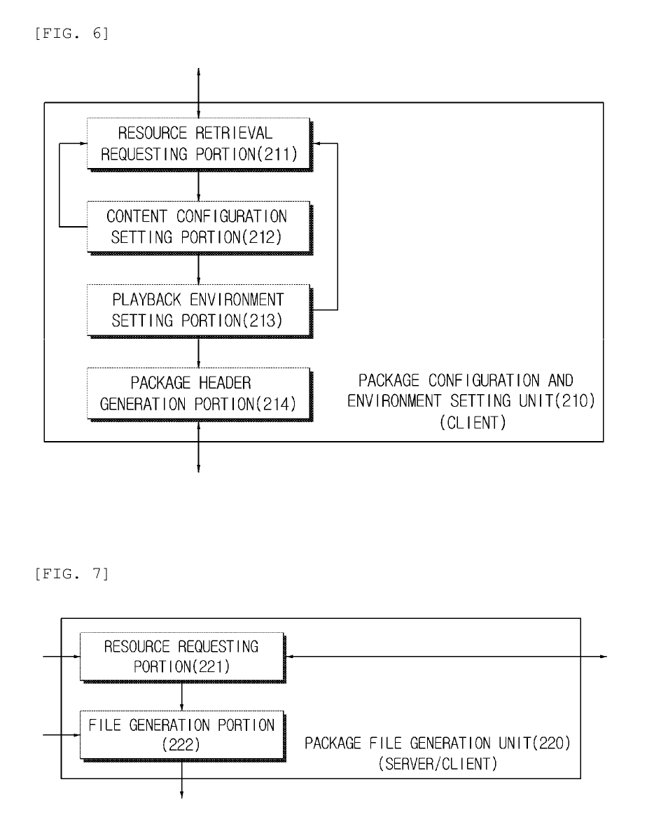

FIG. 5 illustrates a configuration of a resource management unit 240. The resource management unit 240 includes a resource storing and managing interface 241, a resource database 242, a resource retrieval processing portion 243, and a resource output interface 244.

The resource stored in the client 200 is a resource which the user personally has and thus may be managed by using basic information such as a file name, a format, and a multimedia type regarding a file without additional information.

A method for managing the resource in the client 200 may include a method for automatically retrieving, finding, and managing the multimedia file cyclically in a storage device 270 of the client 200 or a method for the user to passively update multimedia file information of a corresponding route by designating the route storing a predetermined multimedia file at the time of producing the multimedia package. As described above, the resource management unit 240 at the client 200 side may perform management to prevent the user from inconvenience in inputting the additional information regarding the multimedia file.

The resource storing and managing interface 241 automatically or passively finds the resource stored in the storage device 270 of the client 200 and stores the resource in the resource database 242 as described above. The resource retrieval processing portion 243 retrieves the resource database 242 when the user inputs a resource retrieval word. The resource retrieval processing portion 243 retrieves the resource database 112 according to the request from the package configuration and environment setting unit 210.

The resource output interface 244 serves to acquire corresponding information from the resource database 242 and transfer the acquired information to the package configuration and environment setting unit 210 or the package file generation unit 220 to be described below when the package configuration and environment setting unit 210 or the package file generation unit 220 requests a resource list or the resource.

The package configuration and environment setting unit 210 serves to select a resource to constitute the multimedia package among the resources managed by the server 100 or the client 200 and set a playback sequence and a playback environment for the selected resource.

FIG. 6 illustrates a configuration of the package configuration and environment setting unit 210. The package configuration and environment setting unit 210 includes a resource retrieval requesting portion 211, a content configuration setting portion 212, a playback environment setting portion 213, and a package header generation portion 214.

The resource retrieval requesting portion 211 requests the resource retrieval by transferring the corresponding retrieval word or query word to the resource management unit 110 of the server 100 or the resource management unit 240 of the client 200 when the user inputs the resource retrieval word. The resource retrieval requesting portion 211 outputs the retrieval result transferred from the resource management unit 210 or the resource management unit 240 through a screen of the client 200. The user may select a desired resource through the screen output. After the user selects the resource, a step for retrieving the resource is performed or a step for setting a content configuration of the multimedia package is performed continuously and additionally.

The content configuration setting portion 212 provides an interface for defining the playback sequence of the resources or the contents to constitute the multimedia package and the relationship between the resources or the contents. The user designates the playback sequence of the contents or the relationship between the contents through the interface provided by the content configuration setting portion 212. However, the content configuration setting portion 212 may also set the playback sequence according to a predetermined rule or arbitrarily without a user's designation.

The playback environment setting portion 213 provides an interface for setting a playback environment of individual contents. The playback environment may include, for example, whether a predetermined song and contents associated with a lyric of the song are simultaneously executed, an image output time interval in a slide show, and the like. The user designates the playback environment through the interface provided by the playback environment setting portion 213. However, the playback environment setting portion 213 may also set the playback environment according to a predetermined rule or arbitrarily without a user's designation.

The setting of the playback sequence or the playback environment may be changed even while the multimedia package file is played back.

When the setting of the playback sequence and the playback environment is completed, the package header generation portion 214 configures playback sequence information and playback environment information as the header of the multimedia package file and provides the information to the package file generation unit 220. The package header generation portion 214 transmits the header and the content list to the package file generation unit 120 of the server 100 when the resource of the server 100 is used to constitute the multimedia package, and transmits the header and the content list to the package file generation unit 220 of the client 200 when the resource of the client 200 is used to constitute the multimedia package. When the multimedia package is configured by using both the resource of the server 100 and the resource of the client 200, the package header generation portion 214 transmits the header and the content list to a package file generation portion designated by the user or one predetermined package file generation portion between the server 100 and the client 200.

The package file generation unit 120 of the server 100 or the package file generating unit 220 of the client 200 generates the multimedia package file by using the multimedia resource depending on the file header and the content list when the header and the content list are transferred from the package configuration and environment setting unit 210.

FIG. 7 illustrates a configuration of a package file generating unit 220. The package file generation unit 220 of the client 200 will be described in FIG. 7 and hereinbelow, but the configuration of the package file generation unit 220 is similarly applied to the package file generation unit 120 of the server 100. The package file generation unit 220 includes a resource requesting portion 221 and a file generation portion 222. The resource requesting portion 221 requests a required resource written in the content list to the resource management unit 110 or 240 of the server 100 or the client 200. When the resource management unit 110 or 240 transfers the resource in response to the request, the file generation unit 220 generates the multimedia package file based on the transferred resource and header. A function for editing or modifying the multimedia package file may be added to the package file generation unit 220.

The package management unit 130 of the server 100 and the package management unit 230 of the client 200 store and manage the multimedia package file generated or modified by the package file generation unit 120 and the package file generation unit 220, respectively. However, the multimedia package file generated by the package file generation unit 120 of the server 100 is transmitted to the client 200 and the package management unit 230 of the client 200 manages the multimedia package file received from the server 100 together with the multimedia package file generated by the client 200. The package management unit 130 of the server 100 may request transmitting the multimedia package file produced by the user to the client 200, and in some cases, the package management unit 130 may allow other users to share or sell the managed multimedia package.

The package file playback unit 250 of the client 200 serves to execute the multimedia package file produced by the user or downloaded from the server. The package file playback unit 250 is a kind of multimedia player.

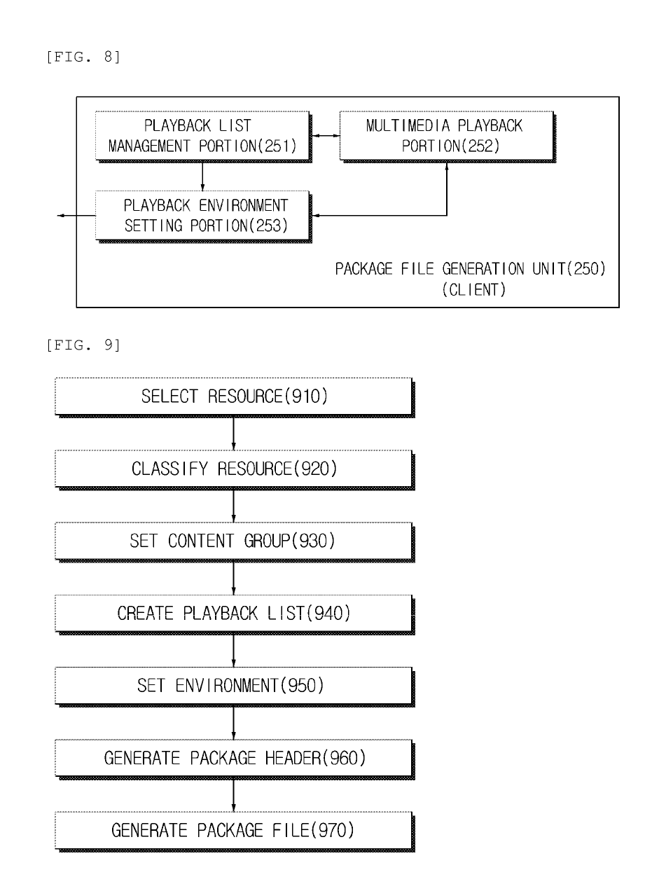

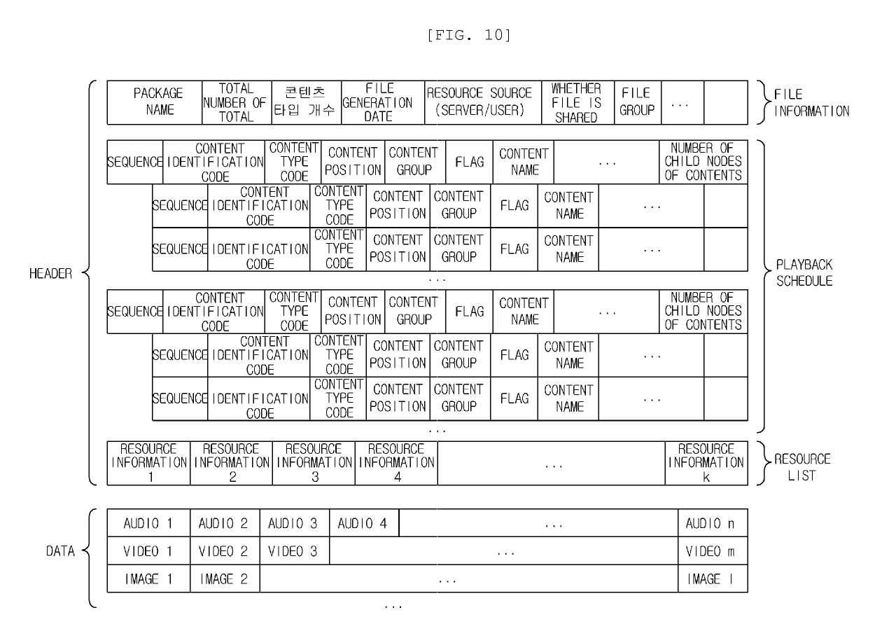

FIG. 8 illustrates a configuration of a package file playback unit 250. The package file playback unit 250 includes a playback list management portion 251, a multimedia playback portion 252, and a playback environment setting portion 253.

The playback list management portion 251 generates and manages a playback list of all contents included in the multimedia package file and a playback list of contents for each multimedia type. In some cases, the user may designate his/her desired individual contents, and in this case, the playback list management portion 251 generates and manages a playback list of the individual contents. The playback list management portion 251 may change a playback sequence of the playback list according to a request from the user. The playback list management portion 251 displays the playback list through a playback interface.

The playback list management portion 251 creates a playback list script of a predetermined type by extracting playback list information from the header of the multimedia package file in order to generate the playback list. When the user requests the change in the playback list through the playback interface, the change is applied to the corresponding playback list. The change is not applied to the header of the multimedia package file as long as there is no additional request from the user. However, when there is the request from the user, the multimedia package file may be modified according to the change.

The playback environment setting portion 253 serves to apply or change environment setting required for a playback while executing the multimedia package file. The playback environment setting portion 253 manages environment setting information together with the content playback list and records the environment setting information for the corresponding content in the playback list script. When the environment setting is changed, the change is applied to only the playback list script and not applied to the multimedia package file, as in the case of the playback list. However, when there is the request from the user, the multimedia package file may be modified according to the change.

As described above, the changes regarding the playback list and the environment setting are applied to the multimedia package file when there is an additional request from the user. In this case, the package file playback unit 250 transfers the changed header and the content list to the package file generation unit 220, and the package file generation unit 220 generates a new multimedia package file or modifies the header of the corresponding multimedia package file depending on the received information.

When the new multimedia package file is generated, the file is generated in the same manner as the original method of generating the multimedia package file by using the content list and the changed header from the package file playback unit 250. While the unchanged multimedia package file is played back even after the generation of the new multimedia package file is completed, the package file generation unit 220 removes the unchanged file after the playback is completed and changes a file name of the newly generated multimedia package file to the unchanged file name.

A function for modifying the file is additionally required with respect to the package file generation unit 220 when only the header of the multimedia package file is modified, and in this case, the package file generation unit 220 changes only a playback schedule and environmental information included in the header without modifying content data of the multimedia package. In the case where there is the request from the user while the corresponding multimedia package file is played back, the package file generation unit 220 modifies the corresponding multimedia package file when the playback is terminated after the package file playback unit 250 additionally stores present playback information.

The multimedia playback portion 252 sequentially executes the contents included in the playback list and plays back the contents by using decoders suitable for the corresponding contents. The multimedia playback portion 252 performs additional functions such as a change in a playback position of an audio or a moving picture, a control of audio volume, and conversion of an output image when playing back the contents. The multimedia playback portion 252 may provide a processing function for playing back contents required to be synchronized, such as a lyric of the audio.

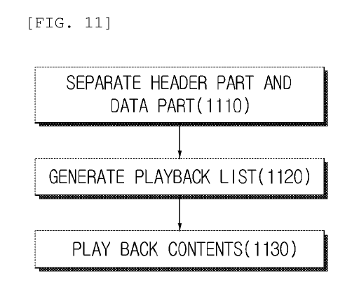

FIG. 9 is a flowchart illustrating a method for producing a multimedia package by the apparatus for producing a multimedia package of FIG. 3 according to an exemplary embodiment of the present invention.

In step S910, the package configuration and environment setting unit 210 selects the resource to constitute the multimedia package from the resources managed by the server 100 or the client 200 according to the request from the user.

The resource selecting step includes a resource retrieval request and an output step of a retrieval result of the resource retrieval requesting portion 211 and a content configuration setting step of the content configuration setting portion 212. In the resource selecting step, the operations of retrieving the resource, outputting the retrieval result, and selecting the resource are repeatedly performed and information on the resource selected by the user is stored. The information will be referred to as resource information. The resource information is different for each multimedia type and may be different depending on whether a storage position of the resource information is the server 100 or the client 200. For example, the sound source may include a title, a singer name, an album title, and the like, and the image may include a type of the image (photos, pictures, advertisements, or pictorials), a compression scheme, a size, a subject, a title, and the like. The resource stored in the client 200 may include only information associated with the corresponding file, such as a file name, a file type, a file format, and a file route so that the user need not perform an additional input.

When the selection of the resource is completed, the package configuration and environment setting unit 210 automatically categorizes the selected resource in step S920. The selected resource is categorized according to the type of the multimedia or the resource information, which is a pre-processing operation for the user to easily retrieve or array the resource at the time of setting the playback list or the playback environment of the contents. The resource information is managed in the file or memory for each item or stored in the database for each multimedia type, such that data may be arrayed in a desired format when there is the request from the user.

In step S930, the package configuration and environment setting unit 210 makes the individual contents belong to one or more groups according to a user's designation or based on a predetermined rule. The content group setting step is used to execute the contents for each group or simultaneously output contents that belong to the same group at the time of playing back the multimedia package file. In simultaneously outputting the contents that belong to the same group, a plurality of multimedia information is outputted on one screen. When the group is designated with respect to the contents, the user may reduce the repeated operations by selecting the group in order to select the contents to be outputted simultaneously. The group may be classified into a user designation group directly designated by the user and a system designation group designated according to a predetermined rule. Group information generated in the step of setting the content group is managed separately from the resource information. The resource information and the group information are required to configure the playback list used when the multimedia package file is initially executed.

In step S940, the package configuration and environment setting unit 210 determines a playback sequence when the multimedia package file is executed by using the resource information and the group information. Herein, the playback list to be used at the time of playing back all the contents of the multimedia package and the playback list for each multimedia type are created. The playback list for each multimedia type may be created by recording the contents sequentially according to the sequence. The playback list of all the contents expresses the audio and the moving picture as a parent node according to a playback sequence and a content executed simultaneously as a child node to be configured in a tree form.

When the creation of the content playback list is completed, the package configuration and environment setting unit 210 performs an environment setting step of designating the relationship between the contents and designating the playback environment of the content in step S950. The relationship information between the contents include whether the content corresponding to the parent node and the content corresponding to the child node are synchronized with each other. This means setting whether a lyric text (child node) is synchronized and outputted according to a playback time of the audio, for example, at the time of outputting the audio (parent node). The playback environment means environmental information when the multimedia are executed, such as the volume of an audio signal, whether subordinated contents are executed, and an image output time interval.

Next, in step S960, the package configuration and environment setting unit 210 configures the file header of the multimedia package by using the resource information, the group information, the playback list information, and the playback environment information.

In step S970, the package file generation unit 120 or 220 requests the resource of the corresponding content to the resource management unit 110 or 240 and generates the multimedia package file based on the resource and the file header.

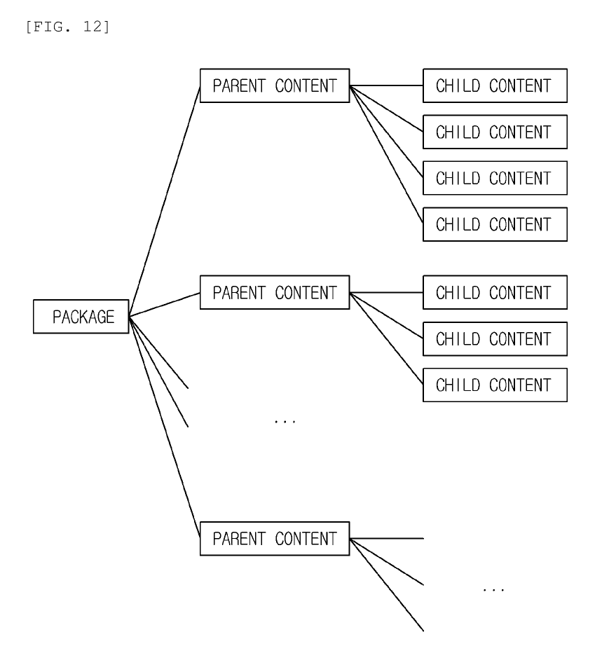

FIG. 10 illustrates an example of a file architecture of a multimedia package file. As illustrated in FIG. 10, the multimedia package file is divided into a header part and a data part. The header part is divided into a file information field, a playback schedule information field, and a resource list field. A package name, the number of contents included in the file, the number of content types, whether the package file is shared, a package file group, and the like are recorded in the file information field. The playback list including the resource, environment, and group information is recorded in the playback schedule information field. The playback sequence of all the contents played back when the package is executed and information on a child content when the child content is provided are recorded in the playback schedule information field together. Information on the resource is recorded in the resource list field according to a storage sequence of the resource in the data part. This is used to generate the playback list for executing the contents for each multimedia type in addition to the playback list of all the contents, and the sequence of the resource information of the resource list field and the storage sequence of the resource in the data part are the same as the sequence of the playback list for each multimedia type during the aforementioned playback list creating step.

The resource files are sequentially recorded in the data part for each multimedia type. The resource files of the data part are not changed after the multimedia package file is initially generated.

FIG. 11 is a flowchart illustrating a method for the package file playback unit 250 to execute the multimedia package file.

In step S1110, the package file playback unit 250 separates the header part and the data part of the multimedia package file.

In step S1120, the package file playback unit 250 extracts the playback list information and the resource list from the header part of the package file and generates the playback list based on the information.

In step S1130, the package file playback unit 250 plays back the contents by sequentially decoding the resource files according to the playback list.

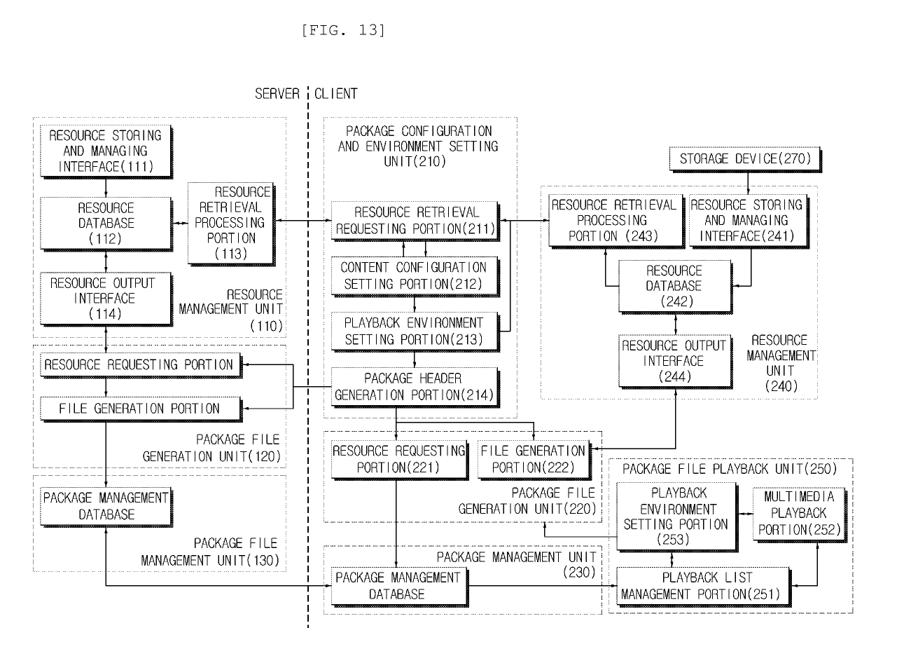

FIG. 12 illustrates an example of a playback list of all contents included in the multimedia package file. The playback list may be expressed in the tree form configured by the parent node corresponding to the parent content and the child node corresponding to the child content subordinated to the parent content, as illustrated in FIG. 12. As described above, the playback list includes the playback list of the contents for each multimedia type and the playback list of the individual contents designated by the user as well as the playback list of all the contents. The playback list management portion 251 of the package file playback unit 250 generates and manages the playback lists.

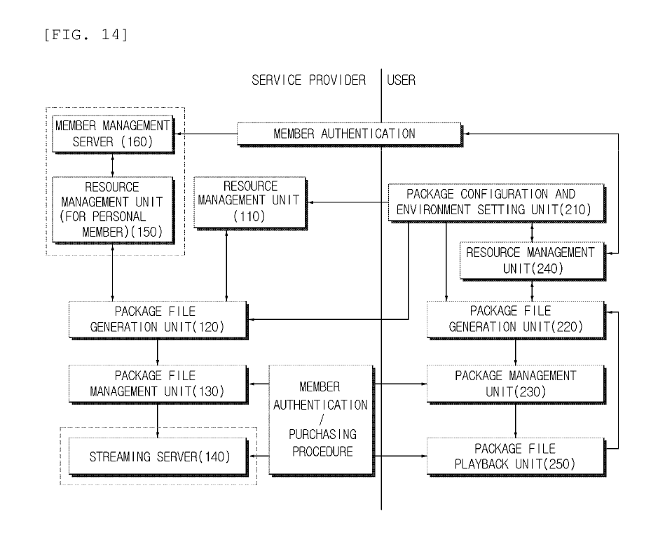

FIG. 13 illustrates an overall configuration of the system for providing a multimedia package service and is a diagram illustrating a flow of data or control information among the respective components by using an arrow. An overall operation of the system for providing a multimedia package service according to the exemplary embodiment of the present invention will be described with reference to FIG. 12.

The package configuration and environment setting unit 210 retrieves and selects the resource to constitute the multimedia package among the resources stored by the resource management unit 110 or 240 of the server 100 or the client 200 and sets a playback sequence, a group, and a relationship playback environment of the contents based on the resource list.

The package configuration and environment setting unit 210 further generates the header of the multimedia package file based on the resource list and the package information and transmits the header and the resource list to the package file generation unit 120 or 220 of the server 100 or the client 200 storing the corresponding resource.

The package file generation unit 120 or 220 requests the corresponding resource to the resource management unit 110 or 240 based on the resource list received from the package configuration and environment setting unit 210, and arrays the resource according to the header information and generates the multimedia package file according to the file format.

The generated multimedia package file is stored in the package file management unit 130 or 230. When the multimedia package file is generated by the server 100, the package file management unit 130 transfers the file to the package file management unit 230 of the client 200. When there is an additional request from the user, the multimedia package file may be downloaded from the server 100.

The package file playback unit 250 calls a user's desired file among the multimedia package files stored in the client 100 to play back the called file by using a multimedia decoder.

When the user requests the change of the playback sequence of the contents within the corresponding multimedia package file, the playback list management unit 251 of the package file playback unit 250 stores the changed playback list. The package file playback unit 250 transfers a header to which the changed playback list is reflected to the package file generation unit 220, and the package file generation unit 220 thus modifies the multimedia package file.

FIG. 14 illustrates a system for performing the method for providing a multimedia package service according to the exemplary embodiment of the present invention. In the case of the system according to the exemplary embodiment of the present invention, a streaming server 140, a member personal resource management unit 150, and a member management server 160 are added to a service provider side in the multimedia package service providing system of FIG. 3. A member authentication procedure is performed between the user and the service provider, and the member authentication procedure and a purchasing procedure are performed when the package file management unit 230 at the client 200 side brings the multimedia package file of the server 100 or the package file playback unit 250 at the client 200 side intends to play back the multimedia package file of the server 100.

The streaming server 140 transfers the multimedia package file stored in the package file management unit 130 of the server 100 to the package file playback unit 250 of the client 200 in a streaming form.

The member management server 160 performs a contract associated with the use of the service and member authentication and manages member information for providing the service.

The member personal resource management unit 150 performs the same function as the resource management unit 110. However, the resource stored in the resource management unit 110 is a resource possessed by the service provider, and the user should go through a legal purchasing procedure in order to use the resource, but the resource stored in the member personal resource management unit 150, as a resource originally possessed by the user or purchased by the user from the service provider, may be utilized without the purchasing procedure.

The multimedia package service providing method according to the exemplary embodiment generally includes a service member subscribing step, a package configuration and environment setting step, a package file generating and managing step, and a package file playback step.

The service member subscribing step will be described below.

First, the user concludes a member subscription contract with the service provider and registers the member information in the member management server 160 in order to receive the service. The member management server 160 individually manages the member information, the resource possessed by the personal member, and the generated multimedia package file. The member management server 160 is required to share the resource possessed by the personal member or the generated multimedia package file with other members. The member management server 160 performs the member authentication in order to verify whether the resource or multimedia package file is shared with other members. An additional purchasing procedure is performed with respect to charged contents.

The package configuration and environment setting step will be described below. The package configuration and environment setting step is performed by the package configuration and environment setting unit 210 of the client 200 of the member.

The user retrieves and selects the multimedia contents to constitute the multimedia package from a resource stored in a storage device of a client device or a resource stored in a server and performs package configuration and environment setting.

Setting the content group within the multimedia package, designating the playback sequence, and defining the relationship between the contents are performed during setting the package configuration, and playback environment setting required to execute individual contents such as the volume of the individual audio, an image output interval, and whether a text is outputted at the time of outputting the audio is performed during setting the environment.

In the group setting step, the group is determined by using keywords which can be used to categorize the multimedia, such as a content author, a title, and a genre or by using a name defined by the user, and the resource is registered in the group. One or more resources need to be included in each group. The resource stored in the server at the time of designating the group includes index information such as the title and the genre for retrieval. Therefore, in the case where the user determines the group with the corresponding keyword, when a function of automatically generating the group is provided, the user may more conveniently set the group. The group setting step is required for an additional function for playing back the multimedia package for each group at the time of playing back multimedia package and thus may be omitted.

In the playback sequence designating step as a step of determining the content playback sequence, the playback list may be created separately for each multimedia type or created regardless of the multimedia type.

In the step of defining the relationship between the contents, the relationship between contents associated with each other, such as a corresponding lyric, a description, or a pictorial in the case of music among the contents is defined. The relationship between the contents means, for example, the relationship between the parent content and the child content as illustrated in FIG. 12.

When the process is completed, the content playback environment is set. A playback environment required in the playback is set according to characteristics for each of individual contents and multimedia. In the service system, a function of collectively applying an environment setting value may be provided according to the multimedia type or by providing several types of environment setting information or environment setting templates. For example, in the case of the image, a previous or subsequent image may be outputted according to the user's input or the subsequent image may be automatically outputted at a time interval designated by the user. In setting the individual contents, an image conversion time interval for the automatic execution is designated. Since the child content may be normally executed only when the child content is executed in synchronization with the parent content, whether the child content is synchronized with the parent content is designated, and as necessary, an additional interface for setting synchronization of the time of the child content with respect to the execution time of the parent content may be provided.

The package file generating and managing step will be described below. The package file generating and managing step is performed by the package file generation unit 220 and the package management unit 230.

When the package configuration and environment setting is completed, the package configuration and environment setting unit 210 generates the header of the multimedia package file based on the resource list, the content playback list, the group information, the environment setting information, and the relationship information between the contents, and transmits the generated header to the package file generation unit 220 together with the resource list.

When the resource stored in the server 100 or the client 200 is used at the time of generating the package file, the above information is transmitted to the package file generation unit 120 or 220 of the corresponding server 100 or the client 200. However, when the multimedia package is configured by mixing the resources stored in both the server 100 and the client 200, an operation of downloading the resource stored in the server 100 in the client 200 or uploading the corresponding resource stored in the client 200 side in the member personal resource management unit 150 in the server 100 side may be first performed.

The package file generation unit 120 or 220 requests the required resource to the resource management unit 110, 150, or 210 and generates the multimedia package file according to an architecture of the file explicitly stated in the header. The file architecture may have a form constituted by the header part including the file information field, the playback schedule information field, and the resource list field and the data part, as illustrated in FIG. 10. Herein, in some cases or some services, required items may be added.

When the generation of the multimedia package file is completed, the corresponding file is stored in the package file management unit 130 or 230. When the file is generated at the server 100 side, the file is transmitted to the package file management unit 230 at the client 200 side. When the multimedia package file is managed for each member and the member wants to download the multimedia package file produced by the member himself/herself to the client 200, the server 100 transmits the multimedia package file to the client 200 after performing the member authentication. The package file management unit 130 at the server 100 side may provide an interface and a package download or streaming service that allows other members to retrieve the multimedia package when the member intends to share the multimedia package which the member itself produces with members other than the member.

The package file playback step will be described below. The package file playback step is performed by the package file playback unit 250.

The user may play back the multimedia package file stored in the client 200 or the multimedia package file stored in the server 100 in the client 200.

In order to execute the multimedia package file, the playback list for the file to be executed needs to be first generated. The package file playback unit 250 displays the playback list as a blank screen when the client is first executed, and outputs a playback list which is recently executed when the client has been ever executed. The package file playback unit 250 provides the playback list and the package file list to allow the user to generate or change the playback list. Information on the multimedia package stored in the client 200 and the multimedia package list which can be played back and is stored in the server 100 are outputted to the package file list. The file on the file list may be added to the playback list through the package file playback unit 250, the playback sequence of the playback list may be changed, or an operation such as deletion in the playback list may be performed. This operation may be changed even in the state where the contents are being executed. The playback list may have a tree structure in which the file name of the multimedia package is set as the parent node and the content that belongs thereto is set as the child node. Child content information may be displayed or hidden. The user may change the sequence of the multimedia package file and the sequence of the contents within the package file. The changed playback list is stored and managed separately in the package file playback unit 250.

When the user selects the multimedia package file or content to be executed in the playback list and requests the execution, the package file playback unit 250 executes the file by using a decoder suitable for the corresponding multimedia format according to the sequence of the content list of the playback list starting from the selected multimedia package file or contents. When there are child contents set to be executed simultaneously, the package file playback unit 250 verifies whether the corresponding child contents operate in temporal synchronization with the parent contents and executes the contents according to the set playback environment setting. The package file playback unit 250 may provide a function for the user to change whether or not to execute the child contents even while the contents are executed.

The package file playback unit 250 may provide the interface that allows the user to change the environment setting as well as the content playback list of the multimedia package, and the changed information is reflected to the playback list managed by the client 200. When the user wants to apply the change to the multimedia package file, the package file playback unit 250 generates a header to which the change is reflected and transfers the generated header to the package file generation unit 220 to request modifying the multimedia package file.

According to the exemplary embodiments of the present invention, the users can produce a multimedia package of an album type by using multimedia shared by another user or a server in addition to the multimedia which the users themselves possess. The users can share a multimedia package which has already been produced, and the user can possess a multimedia package configured to suit his/her taste. Accordingly, an environment capable of generating various multimedia contents is provided, and a user's desired multimedia contents can be serviced.

The exemplary embodiments of the present invention can be used for producing culture contents such as an album and a pictorial of a musician or a singer and commercial contents such as promotion contents using multimedia, according to the purpose of the service, and as a content production service for a person to produce and share personal experience and knowledge in the album type by using photos, moving pictures, and audio.

Meanwhile, the exemplary embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for producing a multimedia package, comprising:
a package configuration and environment setting unit selecting multimedia resources to constitute the multimedia package from multimedia resources stored in a server or a client and setting a playback sequence and a playback environment for the selected multimedia resources; and
a package file generation unit generating the multimedia package file according to the set playback sequence and playback environment by using the selected multimedia resources.

2. The apparatus for producing a multimedia package of claim 1, wherein the multimedia package producing apparatus is provided in the client.

3. The apparatus for producing a multimedia package of claim 1, further comprising:
a resource management unit automatically retrieving and finding the multimedia resource in a storage device of the client, retrieving the multimedia resource according to a request from a user, and providing the multimedia resource to the package file generation unit.

4. The apparatus for producing a multimedia package of claim 1, wherein the package configuration and environment setting unit configures a list of the selected multimedia resources and information on the playback sequence and the playback environment as the header of the multimedia package file to provide the header to the package file generation unit, and the package file generation unit generates the multimedia package file by using the header and the selected multimedia resources.

5. The apparatus for producing a multimedia package of claim 1, further comprising:
a package management unit storing and managing the generated multimedia package file.

6. The apparatus for producing a multimedia package of claim 1, further comprising:
a package file playback unit playing back the generated multimedia package file.

7. The apparatus for producing a multimedia package of claim 6, wherein the package file playback unit generates and displays a playback list of contents and sets the playback environment based on a header of a multimedia package file to be executed.

8. A method for producing a multimedia package, comprising:
selecting multimedia resources to constitute the multimedia package from multimedia resources stored in a server or a client and setting a playback sequence and a playback environment for the selected multimedia resources; and
generating the multimedia package file according to the selected multimedia resources and the set playback sequence and playback environment.

9. The method for producing a multimedia package of claim 8, wherein the setting of the playback sequence and the playback environment and the generating of the multimedia package file are performed by the client.

10. The method for producing a multimedia package of claim 8, further comprising:
configuring a list of the selected multimedia resources and information on the playback sequence and the playback environment as the header of the multimedia package file,
wherein in the generating of the multimedia package file, the multimedia package file is generated by using the header and the selected multimedia resources.

11. A system for providing a multimedia package service, comprising:
a client-side resource management unit managing a multimedia resource stored in a client;
a package configuration and environment setting unit selecting multimedia resources to constitute the multimedia package from multimedia resources stored in a server or the client and setting a playback sequence and a playback environment for the selected multimedia resources;
a client-side package file generation unit generating the multimedia package file according to the set playback sequence and playback environment by using the multimedia resources stored in the client;
a server-side resource management unit managing the multimedia resource stored in the server; and
a server-side package file generation unit generating the multimedia package file according to the set playback sequence and playback environment by using the multimedia resource stored in the server.

12. The system for providing a multimedia package service of claim 11, wherein the server-side resource management unit manages classification information, a copyrighter, and information on a use right for the multimedia resource stored in the server.

13. The system for providing a multimedia package service of claim 11, wherein the client-side resource management unit manages information on a file name, a format, and a multimedia type for the multimedia resource stored in the client.

14. The system for providing a multimedia package service of claim 11, wherein the server-side package file generation unit transmits the generated multimedia package file to the client.

15. A method for providing a multimedia package service, comprising:
registering member information of a member to receive the service and performing member authentication;
selecting multimedia resources to constitute a multimedia package from multimedia resources stored in a server or the client, in the client of the member and setting a playback sequence and a playback environment for the selected multimedia resources; and
generating a multimedia package file according to the selected multimedia resources and the set playback sequence and playback environment.

16. The method for providing a multimedia package service of claim 15, wherein the generating of the multimedia package file is performed by the server or the client.

17. The method for providing a multimedia package service of claim 16, further comprising:
transmitting the generated multimedia package file to the client when the multimedia package file is generated in the server.
